(19) United States
(12) Patent Application Publication
(10) Pub. No.: US 2012/0053998 A1
(43) Pub. Date: Mar. 1, 2012

(54) SYSTEM AND METHOD FOR PROVIDING INTERNET-BASED VEHICLE PARKING REGISTRATION AND RESERVATION

(75) Inventors: William Gibbens Redmann, Glendale, CA (US); Chris Outwater, Santa Barbara, CA (US)

(73) Assignee: Liberty PlugIns, Inc.

(21) Appl. No.: 13/216,173

(22) Filed: Aug. 23, 2011

Related U.S. Application Data
(60) Provisional application No. 61/376,599, filed on Aug. 24, 2010.

(51) Int. Cl. G07B 15/00

(52) U.S. Cl. 705/13

(57) ABSTRACT

A system and method are disclosed for internet-based vehicle registration and reservation, using a license plate as a vehicle identification. The system includes a secure remote database, a unique tag for a vehicle such as a state-issued license plate, and various stationary or mobile license plate reading units. The invention allows for a motorist to register a single vehicle or several vehicles, based on license plate(s). Payments can be made by credit card, general subscription or by any other payment method. Enforcement personnel can query the database to see if a particular parked vehicle has a valid reservation to park in a particular space.

### CROSS-REFERENCE TO RELATED APPLICATION

This application claims the benefit of U.S. Provisional Patent Application No. 61/376,599, filed Aug. 24, 2010, which is incorporated by reference herein in its entirety.

### BACKGROUND OF THE INVENTION

1. Field of the Invention

Embodiments of the present invention relate generally to the field of vehicle parking and more particularly to a system and method for providing internet-based vehicle parking registration and reservation based on an identifier that is typically a license plate number.

2. Background Information

It is known in the art to automatically scan vehicle license plates. Also, automated parking facilities at several locations use this technique to positively identify a vehicle. Current pattern recognition technology can quickly and accurately read most license plates for checking registration and for potential violations. One can register a vehicle at a multi-space pay station so that a license plate is matched to a particular parking spot for a particular duration.

Fraser et al. in U.S. Publication 2010/0191584 teach a method for managing parking rights based on receiving a request for issuing a parking right, the request containing both a unique identifier associated with a parking area and a license plate number identifying a vehicle. This prior art method requires a unique parking location identifier to be determined by a driver from signs or decals at parking spaces. No reservation for parking can be made, and after communicating a request, the driver can only park at the one particular location he has identified. It would be advantageous to have a system that would allow a driver to request parking days, weeks or even months ahead, without committing to some exact parking space at the time of the reservation.

### SUMMARY OF THE INVENTION

The present invention relates to an internet-based system and method for reserving parking spaces, either general parking, or parking spaces with special attributes (including one or more of the location (near a building, in a district, or in the city), the nature of parking (on-street or off-street), the time (which days by date like the 12th or which days by name like M-F, which hours, and which months) or features (a space with charging capability for electric vehicles or hybrids, handicapped, or close to exit) based on price using a license plate number as a vehicle identification. Generally, the system of the present invention includes a secure remote database, a unique tag for a vehicle such as an authority-issued license plate (typically a state-issued license plate), and various stationary or mobile license plate reading units. The invention allows for a motorist to register a single vehicle, or several vehicles, based on license plate(s). The motorist can register and pay for both specific and general parking options within a city or even across cooperating cities who wish to share their databases. Payments can be made by credit card, general subscription or by any other payment method or means. Enforcement personnel can query the database to see if a particular parked vehicle has a valid (paid) reservation and permission to park in that particular type of space.

### BRIEF DESCRIPTION OF THE DRAWINGS

Attention is directed to several drawings that illustrate features of the present invention:

FIG. 1 shows a block diagram of an embodiment of the present invention.

FIG. 2 shows an exemplary reservation entry in a database, in accordance with various embodiments.

FIG. 3 shows a flow chart of an embodiment of a reservation process of a method for providing internet-based universal parking registration and reservation, in accordance with various embodiments.

FIG. 4 shows a flow chart of an embodiment of an enforcement process of a method for providing internet-based universal parking registration and reservation, in accordance with various embodiments.

FIG. 5 is an exemplary flowchart showing a method 500 for providing internet-based vehicle parking registration and reservation, in accordance with various embodiments.

FIG. 6 is a schematic diagram of a system that includes one or more distinct software modules to be executed on a controller of a system so as to perform a method for providing internet-based vehicle parking registration and reservation, in accordance with various embodiments.

Several drawings and illustrations have been presented to further describe embodiments of the invention. The scope of the present invention is not limited to what is shown in the figures.

### DESCRIPTION OF VARIOUS EMBODIMENTS

The present invention relates to a system and method for providing internet-based universal parking registration and reservation. The system includes generally a secure database, a unique vehicle tag such as a state-issued license plate, and a plurality of license plate readers either stationary or mobile.

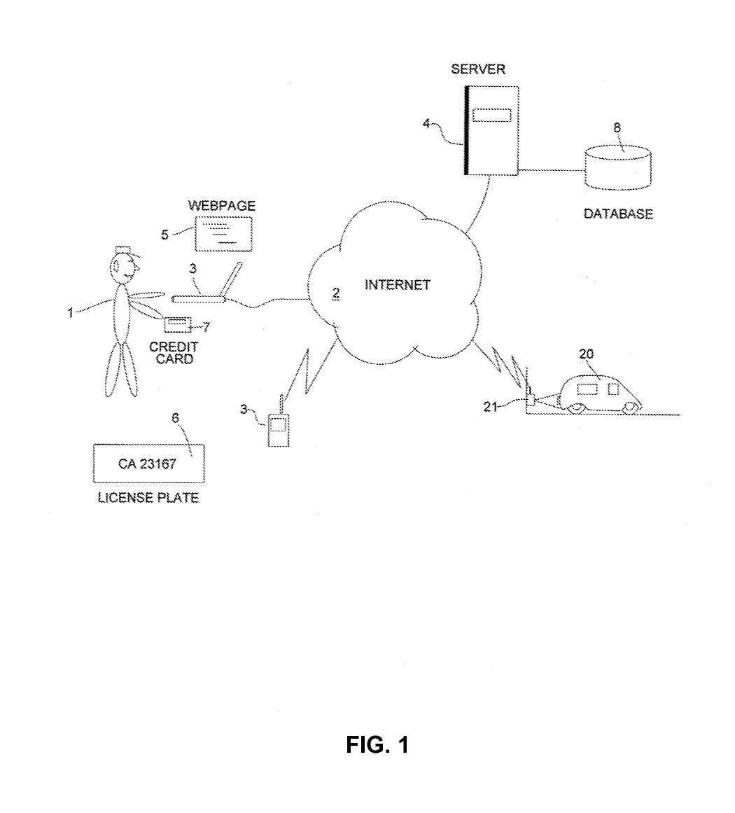

FIG. 1 is a block diagram of a system for providing internet-based universal parking registration and reservation, in accordance with various embodiments. A motorist 1 accesses the internet 2 with a terminal, smart-phone, or other device 3 (also referred to as user device) to provide information regarding the parking registration and reservation. Alternatively, the motorist 1 can give data directly to a parking attendant at a lot. A server 4 presents a secure webpage 5 with several menus to the user to be displayed, for example, on the user device 3. The server 4 also accesses a local or remote secure database 8 (also referred to as secure reservation or permit database) to store and retrieve information regarding parking registration and reservation. The motorist 1 can register one or more license plates 6 during a single session. The webpage 5 can offer a variety of parking options within a city or several cooperating cities for on-street and off-street parking. Payment can be made with a credit card 7, PAYPAL (™), or by any other means over the internet. Arrangements can also be made to pay by check. Payment can be one-time, or the motorist 1 can start a monthly subscription for unlimited parking of a particular type based on time, such as parking for a particular number of days, months or monthly until canceled. The reservation can be based on time, such as parking for one particular day (or particular hours of a particular day), or it can be parking for multiple days during a calendar period (such as weekdays during the month of April). FIG. 1 also shows a vehicle 20 parked in a parking space that is equipped with a license plate scanner 21. While the type of license plate scanner shown in FIG. 1 represents one possibility, any type of scanner or camera, whether stationary or mobile, that can decode or recognize a license plate on a parked or moving vehicle is within the scope of the present invention.

The server 4 contains at least one processor, various memory devices such as read-only memory, random access memory, hard disks and other types of memory devices. The database 8 is generally stored on at least one hard disk or other mass storage device. The server 4 contains at least one communication module allowing access to the internet or other networks (such as private networks). The sever 4, as well as user devices 3 can communicate with wire or wireless techniques.

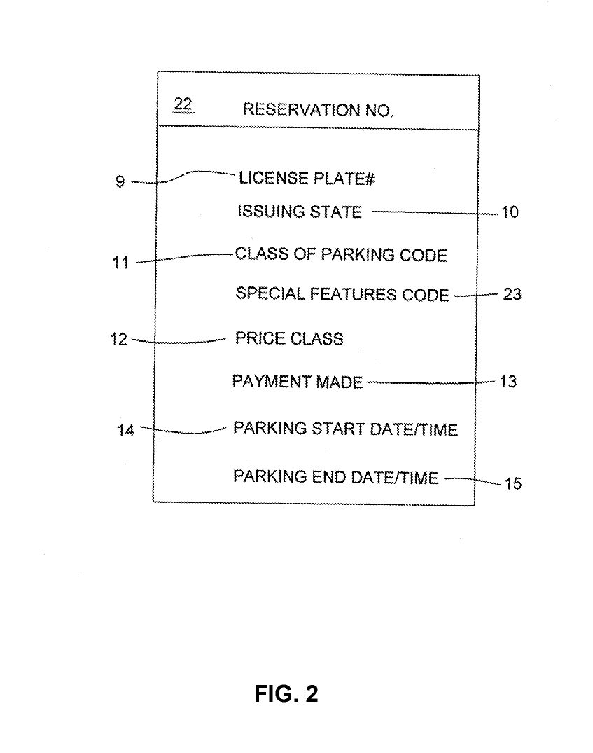

FIG. 2 shows an exemplary entry 22 in the secure reservation or permit database 8, in accordance with various embodiments. The only identifier is a state-issued (or other authority-issued) license plate number 9 and the issuing authority (e.g., state, country) 10. The entry 22 generally represents a single reservation. A particular motorist can make any number of such reservations. The entry 22, for example, identifies a parking type (i.e., parking privilege or parking class) 11, which may include an attribute (or attributes), such as one or more of the location (e.g., near a building, in a district, or in the city), the nature of parking (e.g., on-street or off-street), the time (i.e., which days by date like the 12th or which days by name like M-F, which hours, and which months), or other attributes. Such parking types 11 may be found throughout a municipality. Further the parking type 11 may include a special feature 23 (or features), such as a space with charging capability for electric vehicles or hybrids, handicapped, close to exit, or other special features. The entry 22 includes other fields such as price class 12, payment made field 13, parking start date/time 14, and parking end date/time 15. The database entry 22 shown in FIG. 2 is presented for example only. Any type of entry or record known in the art of databases is within the scope of the present invention. Also, various entries for the same motorist, same vehicle or any other relationship can be connected or related as is known in the database art. Any type of queries may be made against these database entries.

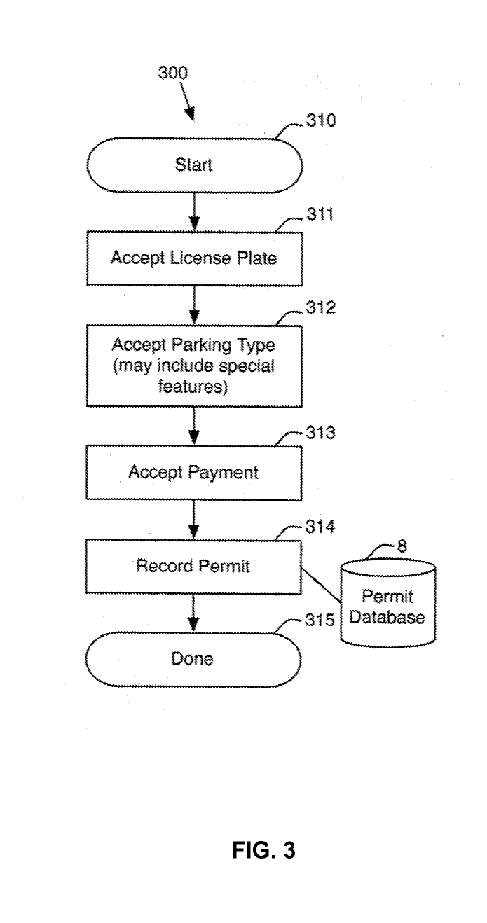

FIG. 3 is a flow chart of an embodiment of a reservation process 300 of a method for providing internet-based universal parking registration and reservation, in accordance with various embodiments. A user begins the process 310 by providing a license plate number 311. Next, a parking type is entered or determined 312, and payment is accepted 313. Once verification is made that the request is valid, and payment has been made, a reservation or permit is recorded 314 in a secure reservation or permit database 8. After the reservation or permit is entered in the database 8, the reservation sequence 300 is complete 315.

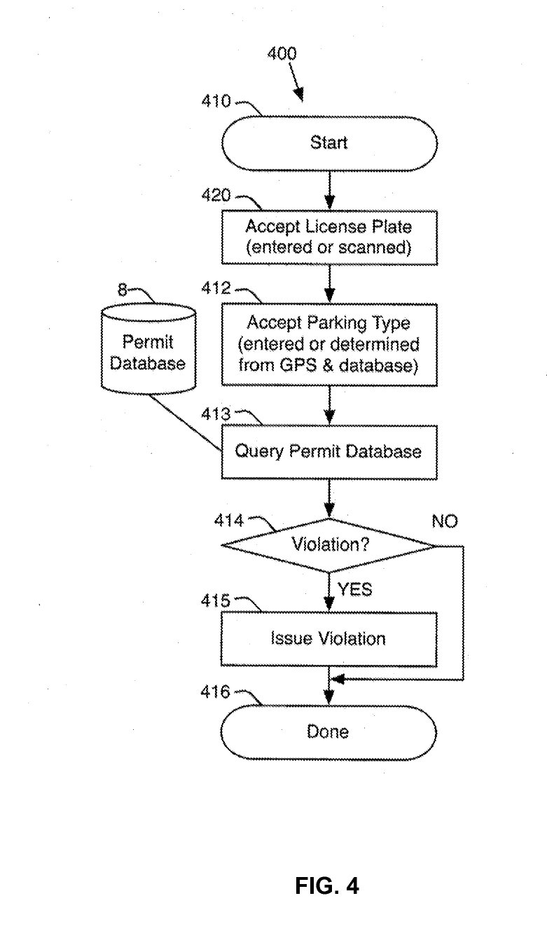

FIG. 4 shows an embodiment of an enforcement process 400 of a method for providing internet-based universal parking registration and reservation, in accordance with various embodiments. The process is entered 410 by identifying 420 a license plate of a parked vehicle. The license plate number can be entered manually, or it can be automatically scanned. The parking type is determined 412 either by the enforcing authority entering it or by location determined by GPS or other location methods, where the determined location is matched against a database. Once the license number and parking type are ascertained, a query 413 can be made against the secure reservation or permit database 8. A determination 414 can then be made whether the vehicle is legally parked (basing the parking on location, time and parking type, for example). If the vehicle is illegally parked, a violation can be issued 415, or the vehicle can be towed. If the vehicle is legally parked, no action would normally be taken and the process exits 416.

The webpage presented to the motorist during the reservation process generally displays a menu or set of menus. The menus can include multiple levels of parking types based on different attributes, such as one or more of the location (e.g., near a building, in a district, or in the city), the nature of parking (e.g., on-street or off-street), the time (i.e., which days by date like the 12th or which days by name like M-F, which hours, and which months), or other attributes along with special features such as electric vehicle charging, handicapped, close to exit, or other features. Menus can be brought up on demand and can represent a hierarchy or family of callable menus. There can be trees of menus at various levels that are made visible as required.

The present invention can be integrated with present systems during a transition away from pay stations and gated lots. For example, in a pay and display situation, if a vehicle appears to be in violation, the enforcing officer would read the license plate automatically or manually, and then check the database either automatically or manually to see if there is an over-riding registration that deters the violation. Premium parking near courthouses, civic centers, sports events, etc. can be purchased on the menu. In a gated parking situation, the license plate can be read upon exit. The motorist can take a ticket like other motorists upon entry, but would not have to pay on exit if already pre-paid (or might pay a reduced price in some circumstances).

With the present invention, parking attendants are not generally needed; however, they can still be used. Drivers can pre-register and drive in to avoid traffic congestion, or a driver who wishes to instead pay an attendant can do so and immediately get their license plate registered for that event or parking situation. The system is completely flexible and can be mixed with any and all existing parking and payment methods. Once registered, the motorist's name, license plate(s), parking menu options and payment information can be saved in the remote secure reservation or permit database 8. Emails can optionally be sent out when the terms are about to expire. The registration and/or request for parking can be similar to the manner a motorist can renew a vehicle registration online. In fact, the registration process can optionally be tied to the vehicle registration process.

Privately owned parking companies currently share license plate information with law enforcement agencies for various enforcement purposes. Such sharing can also be between different cooperating parking authorities. Such sharing may allow motorists in a particular area to park in different cooperating cities. Motorists can also buy a single parking registration for more than one vehicle (when a driver sometimes drives one and sometimes drives another). If the motorist tries to park both vehicles at the same time under a single reservation or permit, an enforcing officer can be informed of a violation. Depending upon parking enforcement policies, this type of violation may be triggered by both vehicles being detected parking within a certain number of minutes of each other (e.g., within a hour), or a broader period (e.g., on the same day) using the same reservation or permit.

In the field, parking enforcement officers and vehicles can carry remote license plate reading capability. Even officers with no ability to electronically or automatically read the license plate can call a particular telephone number and read the plate number into an automated system, or type the license plate number into a smart-phone application, to get an instant response as to the parking types paid for that license plate. Optionally, enforcing officers can use a GPS to determine exactly where they are and exactly where the vehicle is. This data can then be checked against the secure reservation or permit database 8 to see if a particular vehicle has purchased parking types at that location and time. Enforcement can also be effected by systems of cameras with license plate reading recognition software either in the camera or at a remote computer.

One of the particular types can be parking with electric vehicle charging capabilities. This parking type can be accessible through a code offered at the time of parking or by pre-reservation. Enforcement can be based solely on the paid parking types.

In the unique situation of pay-and-display parking, the enforcing officer can first look to see if the vehicle is displaying a proper ticket. If not, the license plate can be scanned to see if there is a paid reservation. If neither of these is true, a citation can be issued or the vehicle can be towed.

The present invention presents an efficient, internet-based solution to parking. It allows motorists great flexibility on choosing parking options, and it is compatible with current parking facilities such as pay-and-display, gate entry, other types of pay stations and the like.

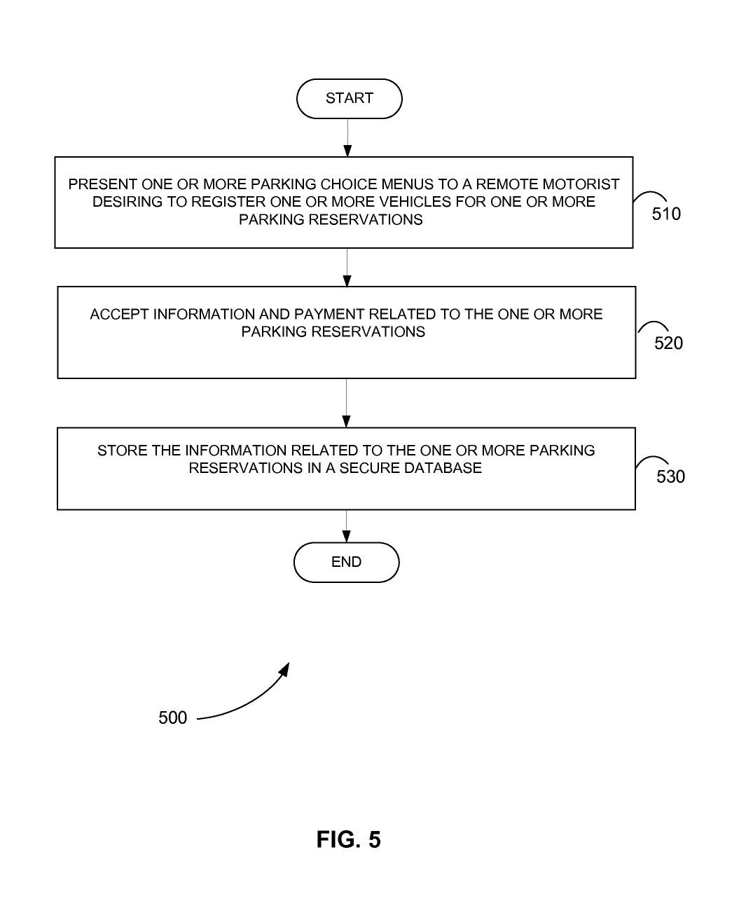

FIG. 5 is an exemplary flowchart showing a method 500 for providing internet-based vehicle parking registration and reservation.

In step 510 of method 500, one or more parking choice menus are presented to a remote motorist desiring to register one or more vehicles for one or more parking reservations. Parking choice menus may allow a motorist to select a parking type.

In step 520, information and payment related to the one or more parking reservations are accepted.

In step 530, the information related to the one or more parking reservations is stored in a secure database.

In various embodiments, method 500 accepts a license plate number of a parked vehicle, accepts a parking type of the parked vehicle, and queries the secure database to determine if the parked vehicle has a valid reservation in the secure database.

In various embodiments, method 500 issues a violation if the parked vehicle does not have a valid reservation in the secure database. In various embodiments, method 500 automatically scans the license plate number of the parked vehicle. In various embodiments, method 500 uses GPS methods to determine the parking type based on a location of the parked vehicle. In various embodiments, method 500 displays the one or more parking choice menus on a user device. In various embodiments, method 500 wirelessly transmits the information related to the one or more parking reservations to the secure database.

In various embodiments, a computer program product includes a non-transitory and tangible computer-readable storage medium whose contents include a program with instructions being executed on a controller of a system so as to perform a method for providing internet-based vehicle parking registration and reservation. This method is performed by a system that includes one or more distinct software modules.

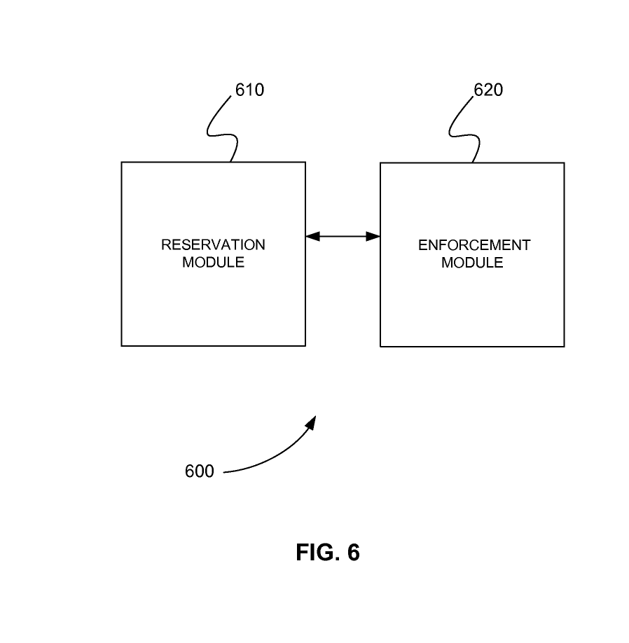

FIG. 6 is a schematic diagram of a system 600 that includes one or more distinct software modules to be executed on a controller of a system so as to perform a method for providing internet-based universal parking registration and reservation, in accordance with various embodiments. System 600 includes registration module 610 and enforcement module 620.

Registration module 610 presents one or more parking choice menus to a remote motorist desiring to register one or more vehicles for one or more parking reservations, accepts information and payment related to the one or more parking reservations, and stores the information related to the one or more parking reservations in a secure database.

Enforcement module 620 accepts a license plate number of a parked vehicle, accepts a parking type of the parked vehicle, and queries the secure database to determine if the parked vehicle has a valid reservation in the secure database.

Several descriptions and illustrations have been presented to aid in understanding various features of the present invention. One with skill in the art will realize that numerous changes and variations are possible without departing from the spirit of the invention. Each of these changes and variations is within the scope of the present invention.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for providing internet-based vehicle parking registration and reservation, comprising:
a server operationally connected to the internet adapted to present one or more parking choice menus to a remote motorist desiring to reserve parking;
a database connected to the server, the database storing one or more parking reservations made by the motorist;
wherein the motorist supplies payment and a vehicle license plate as identification to secure a reservation for parking.

2. The system of claim 1, wherein the server is adapted to access the database upon query on a license plate number to determine if a particular parked vehicle has a valid reservation in the database.

3. The system of claim 2, further comprising a license plate scanner that automatically scans the license plate number of a parked vehicle and transmits the scanned license plate number to the server.

4. The system of claim 2, wherein the license plate number of a parked vehicle is manually entered by a parking attendant to be wirelessly transmitted to the server.

5. The system of claim 1, wherein the one or more parking choice menus are displayed on a user device.

6. The system of claim 5, wherein the user device is one or more of a computer terminal and a smart-phone.

7. The system of claim 1, wherein the database is remotely and wirelessly connected to the server.

8. The system of claim 1, wherein the motorist registers one or more license plates during a single session using the one or more parking choice menus.

9. The system of claim 1, wherein the payment includes one or more of a credit card payment, PAYPAL payment, check payment, and a monthly subscription.

10. The system of claim 1, wherein the reservation for parking is based on one or more attributes including a location of parking such as near a building, in a district and in a city, a nature of parking such as on-street or off-street, and a time of parking such as a particular day, particular hours of a particular day, and multiple days during a calendar period.

11. The system of claim 1, wherein the reservation for parking is based on one or more features including electric vehicle charging, handicapped, close to exit.

12. A method for providing internet-based vehicle parking registration and reservation, the method being implemented by a computer including one or more processors, the method comprising:
presenting one or more parking choice menus to a remote motorist desiring to register one or more vehicles for one or more parking reservations;
accepting information and payment related to the one or more parking reservations; and
storing the information related to the one or more parking reservations in a secure database.

13. The method of claim 12, further comprising:
accepting a license plate number of a parked vehicle;
accepting a parking type of the parked vehicle; and
querying the secure database to determine if the parked vehicle has a valid reservation in the secure database.

14. The method of claim 12, further comprising issuing a violation if the parked vehicle does not have a valid reservation in the secure database.

15. The method of claim 12, wherein the accepting a license plate number step includes automatically scanning the license plate number of the parked vehicle.

16. The method of claim 12, wherein the accepting the parking type step includes using GPS methods to determine the parking type based on a location of the parked vehicle.

17. The method of claim 12, wherein the presenting step includes displaying the one or more parking choice menus on a user device.

18. The method of claim 12, further comprising wirelessly transmitting the information related to the one or more parking reservations to the secure database.

19. A computer program product, comprising a tangible, non-transitory computer-readable storage medium whose contents include a program with instructions being executed on a processor so as to perform a method for providing internet-based vehicle parking registration and reservation, the method comprising:
presenting one or more parking choice menus to a remote motorist desiring to register one or more vehicles for one or more parking reservations;
accepting information and payment related to the one or more parking reservations; and
storing the information related to the one or more parking reservations in a secure database.

20. The computer program product of claim 19, wherein the method further comprising:
accepting a license plate number of a parked vehicle;
accepting a parking type of the parked vehicle; and
querying the secure database to determine if the parked vehicle has a valid reservation in the secure database;
